(19) United States
(12) Patent Application Publication
(10) Pub. No.: US 2014/0054991 A1
(43) Pub. Date: Feb. 27, 2014

(54) Mechanical and Electrical-Integrated Drive Unit

(71) Applicant: HITACHI AUTOMOTIVE SYSTEMS, LTD., (US)

(72) Inventor: Minoru HYODO, Isesaki (JP)

(73) Assignee: HITACHI AUTOMOTIVE SYSTEMS, LTD., Hitachinaka-shi (JP)

(21) Appl. No.: 13/764,805

(22) Filed: Feb. 12, 2013

(30) Foreign Application Priority Data
Mar. 23, 2012 (JP) 2012-067189

(51) Int. Cl. H02K 11/00

(52) U.S. Cl. CPC H02K 11/0073
USPC 310/71

(57) ABSTRACT

A mechanical and electrical-integrated drive unit is provided that is configured to be able to protect a control circuit board from thermal stress, a contaminant, or operating fluid from a motor housing chamber and that can improve the flexibility of layout of electronic components mounted on the control circuit board. The drive unit includes a motor, a control circuit board for controlling energization of the motor, the circuit board installed integrally with the motor, an obstruction portion isolating the motor from the circuit board, and an inverter housing for the circuit board. A coil wire of the motor is covered at its end by a conductive thin-walled narrow tube so as to be joined to the tube. The tube is fixedly inserted into a through-hole formed in the obstruction portion so that at least the leading end portion of the tube is projected into the inverter housing.

### BACKGROUND OF THE INVENTION

1. Field of the Invention

The present invention relates to a mechanical and electrical-integrated drive unit.

2. Description of the Related Art

In the conventional technology disclosed in JP-2005-229658-A, the coil wire of the motor housed in the motor chamber is arranged to extend to the housing provided with the control circuit chamber housing the control circuit board therein. In addition, the coil wire is joined to the connecting terminal which is previously secured to the housing. Thus, the coil wire is electrically connected to the control circuit board.

### SUMMARY OF THE INVENTION

The conventional technology described above has the structure in which the terminal formed on the motor is projected into the control circuit chamber. Accordingly, since the opening exists between the motor chamber and the control circuit chamber, the control circuit chamber is easily subjected to heat generated by the motor portion. Further, if a contaminant occurs inside the motor chamber, or if operating fluid leaks into the motor chamber, it can reach the control circuit chamber.

The conventional technology disclosed in JP-2006-262611-A needs to dispose the connecting terminals on the insulator (which is a member that establishes insulation between the stator core and the wound stator windings) formed on the end face of the motor body. Therefore, there is a problem about low flexibility of layout of electronic components mounted on the control circuit board.

It is an object of the present invention to provide a mechanical and electrical-integrated drive unit that is configured to electrically connect a motor coil with a control circuit board and that can improve the flexibility of layout of electronic components mounted on the control circuit board while minimizing influences of heat generated by a motor and of a contaminant on the control circuit chamber.

According to an aspect of the present invention, there is provided a mechanical and electrical-integrated drive unit comprising: a motor; a control circuit board adapted to control energization of the motor, the motor and the control circuit board being installed integrally with each other; a conductive tubular member for joining a coil wire of the motor to the control circuit board; a divider wall isolating the motor from the control circuit board; and a case to house the control circuit board therein; wherein the coil wire of the motor is covered at an end thereof by the conductive tubular member and the coil wire and the tubular member are joined to each other, and the tubular member is fixedly inserted into a through-hole formed in the divider wall in such a manner that at least an leading end portion of the tubular member is projected into the inside of the case, and the tubular member is joined to the control circuit board.

The aspect of the present invention can minimize an influence of the heat generation of the motor or of a contaminant on a control circuit board chamber and improve the flexibility of layout of electronic components mounted on the control circuit board.

### BRIEF DESCRIPTION OF THE DRAWINGS

FIG. 1 is a longitudinal cross-sectional view of an electric oil pump according to a first embodiment.

FIG. 2 is a longitudinal cross-sectional view illustrating a joint structure between a control circuit board 27 and a coil wire 53 according to the first embodiment.

FIGS. 3A and 3B are transverse cross-sectional views of various portions of a thin-walled narrow tube 60 encountered during the formation thereof.

FIG. 4 is a longitudinal cross-sectional view illustrating the state where the thin-walled narrow tube 60 is bent.

FIG. 5 is a longitudinal cross-sectional view illustrating the state where the opening 60a side of the thin-walled narrow tube 60 is largely projected toward a motor housing portion 13.

FIGS. 6A, 6B and 6C are longitudinal cross-sectional views of thin-walled narrow tubes according to other embodiments.

FIG. 7 is a longitudinal cross-sectional view of a thin-walled narrow tube according to another embodiment.

### DESCRIPTION OF THE PREFERRED EMBODIMENTS

A mechanical and electrical-integrated drive unit according to embodiments of the present invention will hereinafter be described with reference to the drawings.

### Embodiment 1

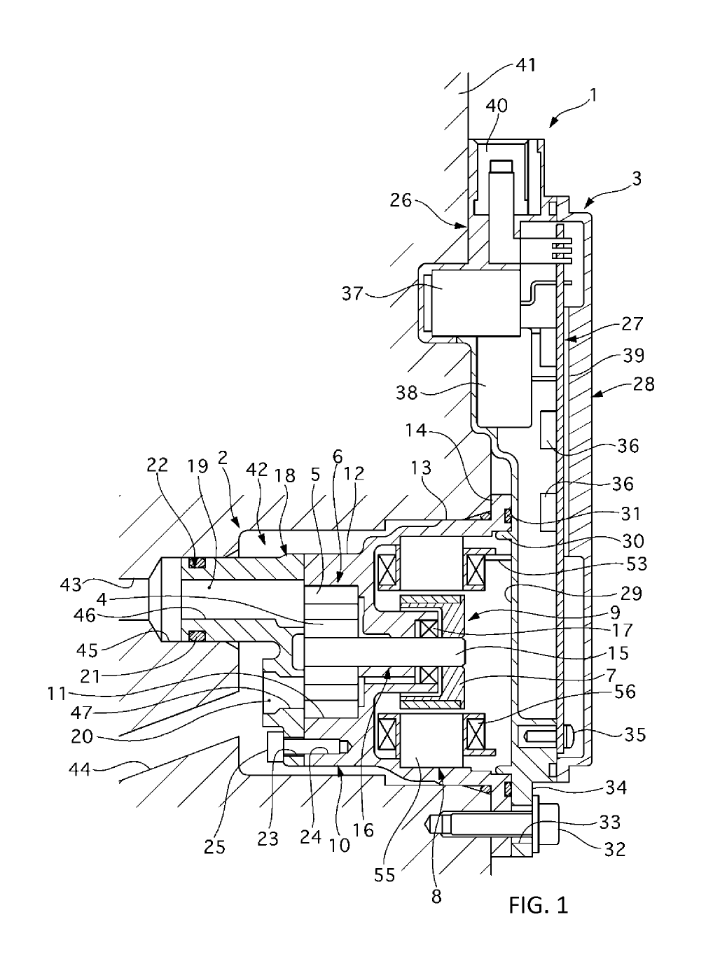

FIG. 1 is a longitudinal cross-sectional view of an electric oil pump (a mechanical and electrical-integrated drive unit 1) according to a first embodiment.

The electric oil pump 1 of the first embodiment is a pump mounted for an automatic transmission for a vehicle equipped with a function to stop an engine when the vehicle is stopped. The automatic transmission separately has a main (mechanical) pump driven by the rotative power from the engine or a motor. When the engine is stopped, however, also the mechanical pump is not operative and therefore hydraulic pressure cannot be produced. Further, if the hydraulic pressure lowers due to a cause inside the automatic transmission, time is taken until the hydraulic pressure necessary for re-start is ensured, leading to degraded drive performance in some cases. Therefore, the electric oil pump 1 which can deliver hydraulic pressure regardless of the operating conditions of the engine is installed separately from the main pump. In this way, the necessary hydraulic pressure is covered, thereby achieving an improvement in the drive performance during re-start of the engine and the vehicle.

The electric oil pump 1 is a mechanical and electrical-integrated electric oil pump in which an oil pump portion 2 and an inverter portion 3 are installed integrally with each other.

### (Configuration of the Oil Pump Portion 2)

The oil pump portion 2 includes a pump 6 and a motor 9. The pump 6 is composed of an inner rotor 4 having an external tooth and an outer rotor 5 having an internal tooth. The motor 9 is composed of a motor rotor (a rotor) 7 connected to the inner rotor 4 and a stator 8.

The pump 6 and the motor 9 are housed in a single center housing 10. The center housing 10 is formed of a material, such as aluminum die-cast, having a higher coefficient of thermal conductivity than that of a resin material. The center housing 10 has, at both ends, openings facing the axial outside (the right side of FIG. 1). A tubular pump-housing portion 12 is formed at the inner circumference of one of the openings and is formed with a pump element housing portion 11 rotatably housing the outer rotor 5. A motor housing portion 13 is formed at the inner circumference of the other of the openings. The motor housing portion 13 fixedly supports the stator 8 and houses the motor rotor and the like in the interior portion (the motor chamber). Further, the center housing 10 is formed, on the axial outside of the motor housing portion 13, with a bracket 14 used to mount the center housing 10 to the automatic transmission.

The stator 8 is composed of cores 55 and coils 56. The core 55 is formed of stacked electromagnetic steel plates and has a tubular core body and a plurality of teeth provided on the inner circumferential side of the core body so as to project therefrom. The coil 56 is formed of coil wires wound around the teeth. An insulator made of resin is installed between the core body and the wounded coil to keep electric insulation between the cores 55 and the coils 56. Incidentally, the motor 9 of the first embodiment is a 3-phase brushless motor. The cores 55 and the coils 56 are installed by a multiple of phases U, V, W.

The center housing 10 has a bearing 16 and a divider wall therein. The bearing 16 rotatably supports a rotor drive shaft 15. The divider wall connects the bearing 16 with the outer circumference of the center housing 10 and separates the pump housing portion 12 from the motor housing portion 13. The bearing 16 supports the rotor drive shaft 15 at the inner circumference thereof. A seal member 17 is installed at an end portion on the motor housing portion 13 side so as to seal between the rotor drive shaft 15 and the inner circumference of the bearing 16.

A pump cover 18 has a cylindrically extending discharge portion 19 communicating with a discharge area as a pump element, and a suction portion 20 communicating with a suction area as a pump element. A seal ring groove 22 to which a seal ring 21 is attached is formed on the outer circumference of an end of the discharge portion 19. The pump cover 18 is formed with bolt holes 23 at three positions in a circumferential direction. The center housing 10 is formed with bolt holes 24. The pump cover 18 is fixedly fastened to the center housing 10 by bolts 25 inserted into the bolt holes 23, 24.

### (Configuration of the Inverter Portion 3)

The inverter portion 3 has an inverter housing (a case) 26, a control circuit board 27 and a heat sink 28.

The inverter housing 26 includes a resin-made obstruction portion (a divider wall) 29 obstructing the motor housing portion 13; a cylindrical upright portion 30 installed to extend upright from the obstruction portion 29 and inserted into the inside wall of the motor housing portion 13; and a flange plate 34 coming into contact with a flange surface of the bracket 14 to press the seal member 31 and having a through hole 33 adapted to receive a bolt 32 inserted therethrough. In this way, the inside (the motor chamber) of the motor housing portion 13 is formed as a dry-side. In addition, the inside (the pump chamber) of the pump housing portion 12 and the outer circumference of the pump are formed as a wet-side.

The control circuit board 27 is housed in the inside (a control circuit chamber) of the inverter housing 26 and is fastened to the inverter housing 26 by means of a plurality of bolts 35. FETs 36, a CPU not shown and other parts are mounted on the front of the control circuit board 27 and a capacitor 37 and an inductor 38 are attached to the control circuit board 27. A heat conductive sheet 39 formed like a flat plate is installed corresponding to the FETs 36, at a position between the control circuit board 27 and the heat sink 28.

The heat sink 28 is installed on the inverter housing 26 so as to obstruct it.

The inverter portion 3 sequentially supplies a DC current supplied from a battery not shown via a connector 40, to phases U, V, W of the coils 56 by the switching of the FETs. A description is later given of the electric joint structure between the control circuit board 27 and the coil wire 53. The coil wire 53 is installed for each of the U-, V- and W-phases.

The electric oil pump 1 of the first embodiment is housed in a pump housing hole 42 formed in the housing 41 of the automatic transmission. The pump housing hole 42 has an opening communicates with an outlet passage 43 adapted to apply hydraulic pressure to a control valve unit not shown and an opening communicates with a suction passage 44 communicating with an oil inlet opening communicating with the inside of an oil pan not shown. The outlet passage 43 is formed with an enlarged-diameter portion 45 facing the pump housing hole 42. The discharge portion 19 of the pump cover 18 is fitted to and supported by the enlarged-diameter portion 45 by being inserted thereinto. A portion between the outlet passage 43 and the pump housing hole 42 is sealed by the seal ring 21. The outlet passage 43 is communicated with the discharge area serving as the pump element via an outlet port 46 formed in the discharge portion 19.

### (Joint Structure Between the Control Circuit Board 27 and the Coil Wire 53)

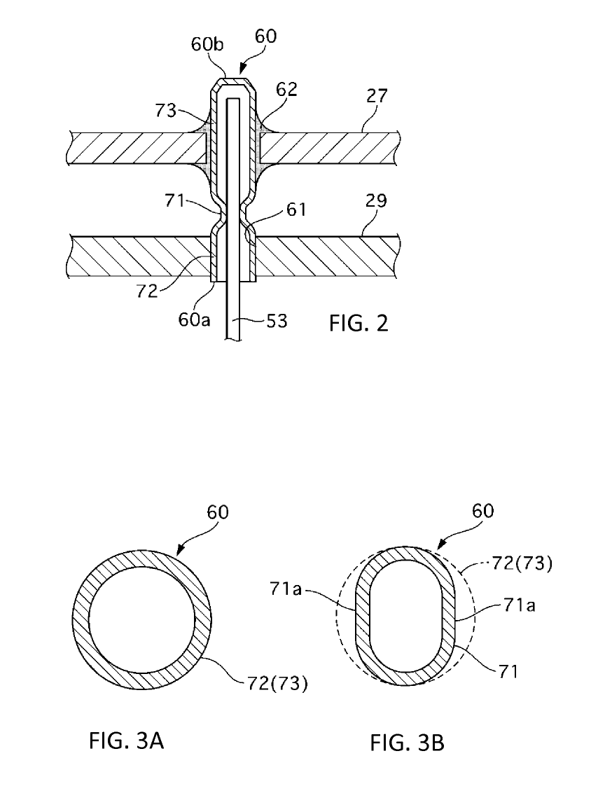

FIG. 2 illustrates a joint structure between the control circuit board 27 and the coil wire 53 according to the first embodiment. A thin-walled narrow tube (a tubular member) 60 is used as means for electrically connecting the control circuit board 27 with the coil wire 53 in the first embodiment.

The thin-walled narrow tube 60 is made of e.g. aluminum, an aluminum alloy, copper, or a copper alloy. The thin-walled narrow tube 60 is formed in a substantially cylindrical shape having an opening 60a at one end and a bottom portion 60b at the other end by a deep drawing process, by curling and brazing a flat plate or by other processes. The thin-walled narrow tube 60 is set at an axial dimension greater than a distance between the control circuit board 27 and the obstruction portion 29. The thin-walled narrow tube 60 has strength greater than that of the coil wire 53. However, the thin-walled narrow tube 60 is set at such strength as to be simply bent by worker's hands.

The coil wire 53 has a leading end inserted into the inside of the thin-walled narrow tube 60. The coil wire 53 and the thin-walled narrow tube 60 are electrically bonded together at a coil wire joint portion 71 located at the axially central position of the thin-walled narrow tube 60 by fusing, resistance welding or other processing.

The thin-walled narrow tube 60 has a press-fitting portion 72 formed at an end portion on the opening 60a side. The press-fitting portion 72 is fixedly press-fitted to a through-hole 61 formed in the obstruction portion 29. Further, the through-hole 61 can completely be sealed by applying an adhesive between the press-fitting portion 72 and the through-hole 61. Incidentally, the press-fitting portion may be insert-molded during the formation of the inverter housing 26 in place of the press-fitting.

The thin-walled narrow tube 60 has a soldering portion 73 formed in the vicinity of an end portion thereof on the bottom portion 60b side. The soldering portion 73 is electrically joined to the control circuit board 27 by soldering 62. The thin-walled narrow tube 60 is previously subjected on the outer circumference thereof to surface treatment (e.g. tin plating) with consideration given to soldering performance.

FIGS. 3A and 3B are transverse cross-sectional views of various portions of the thin-walled narrow tube 60 encountered during the formation thereof.

FIG. 3A is a transverse cross-sectional view of each of the press-fitting portion 72 and the soldering portion 73. The press-fitting portion 72 and the soldering portion 73 are each formed in a cylindrical shape. Incidentally, the press-fitting portion 72 and the soldering portion 73 may have the same diameter or different diameters.

FIG. 3B is a transverse cross-sectional view of the coil wire joint portion 71. The coil wire joint portion 71 is formed with a portion having width across flats (reduced-diameter portion) 71a, 71a resulting from being partially concaved relative to the press-fitting portion 72 and the soldering portion 73 by a forming process.

A description is given of the function of the mechanical and electrical-integrated drive unit.

Conventionally, a mechanical and electrical-integrated drive unit composed integrally of a motor and an inverter has heretofore been configured as below. A housing made of resin for accommodating a control circuit board is formed with a through-hole. A coil wire is arranged to extend to the inside of the housing via the through-hole. The coil wire is bonded to a connecting terminal that has previously been insert-molded to an inverter housing (a case) by welding, fusing, brazing or the like. In this way, the coil wire and the control circuit board are electrically connected via the connecting terminal. The reason why the coil wire and the control circuit board are electrically connected via the connecting terminal is as below. If the coil wire is directly soldered to the control circuit board, cracks occur inside the solder due to the movement of the coil wire during the solidification of the solder. In addition, solderability degrades due to the influence of an oxidized film on the surface of the coil wire. These are likely to decrease reliability.

The conventional technology described above, however, has disadvantages as listed below.

1. In the structure where the terminal formed on the motor projects into the control circuit chamber, or the structure where the coil wire is directly arranged in the control circuit chamber, the through-hole is set at a diameter greater than that of each of the terminal and the coil wire with consideration given to productivity. Therefore, a high-temperature atmosphere due to the heat generation of the motor is likely to apply thermal stress to the control circuit board. Further, if a contaminant occurs inside the pump housing portion or if operating fluid leaks into the motor housing portion, there is concern that the contaminant or the operating fluid enters the inside of the resin-made case via the through-hole and damages the control circuit board.

2. It is necessary for the connecting terminal to be disposed on the inverter housing (the case). Therefore, the layout of the connecting terminal fixedly insert-molded to the inverter housing and electronic components mounted on the control circuit board becomes tight. More specifically, the position of the through-hole for the coil wire and the joint position between the connecting terminal and the control circuit board are offset from each other. The offset and the location of the connecting terminal close to the through-hole need a specified interval depending on the method of joining the coil wire to the connecting terminal. This degrades layout performance.

3. It is necessary to change the shape of the connecting terminal, that is, to install a new mold every time specifications are modified. In short, flexibility for the modification of the specifications is low.

4. Depending on constructing methods problems occur that the layout is further restricted, setting conditions are complicated or equipment investment is increased.

On the other hand, the present embodiment is configured such that the thin-walled narrow tube 60 is installed to cover the leading end of the coil wire 53 and is joined to the control circuit board 27, whereby the coil wire 53 and the control circuit board 27 are electrically connected to each other.

The thin-walled narrow tube 60 is formed like a cylinder with a small diameter. In addition, the position of the through-hole 61 and the joint position between the thin-walled narrow tube 60 and the control circuit board 27 can arbitrarily be set. Therefore, the flexibility of the layout of the joint position between the thin-walled narrow tube 60 and the control circuit board 27 and of electronic components mounted on the control circuit board 27 can be increased. In addition, because of the simple structure in which the coil wire 53 is inserted at its end portion into the inside of the thin-walled narrow tube 60, the joint structure between the coil wire 53 and the control circuit board 27 can be simplified.

The thin-walled narrow tube 60 can minimize the opening area of the through-hole 61. In addition, the gap between the thin-walled narrow tube 60 and the obstruction portion 29 is sealed with an adhesive or the like. Thus, the control circuit board 27 can be protected from the high-temperature atmosphere and the entering of operating fluid or a contaminant.

The thin-walled narrow tube 60 is configured to be secured to the obstruction portion 29 of the inverter housing 26 to which the control circuit board 27 is mounted. That is to say, the thin-walled narrow tube 60 is secured to the obstruction portion 29; therefore, when it is to be fixedly press-fitted to the opening portion (the through-hole 61) formed in the obstruction portion 29, the positioning of the thin-walled narrow tube 60 with respect to the control circuit board 27 can be facilitated. This can improve workability during assembly.

Since the transverse cross-sectional shape of the thin-walled narrow tube 60 is circular, solderability can be improved compared with the above-mentioned conventional technology in which the transverse cross-sectional shape of the connecting terminal is rectangular. In addition, concentration of stress on the interface can significantly be alleviated.

Another conventional technology as disclosed in JP-2006-262611-A is known in which the connecting terminal is not inserted to the inverter housing (the case) but the connecting terminals disposed on the motor side are directly soldered to the control circuit board via a through hole. In this configuration, the connecting terminals are held by the insulator concurrently when the stator core of the motor is molded of resin and the insulator is formed.

However, this conventional technology lowers the flexibility of the shape of the connecting terminal due to the restriction on forming and coiling. Also the joining with the coil wire has low flexibility due to the restriction on layout in many cases. Further, the conventional technology has low flexibility to deal with the modification of the pattern of the control circuit board and the change of the motor in size and position.

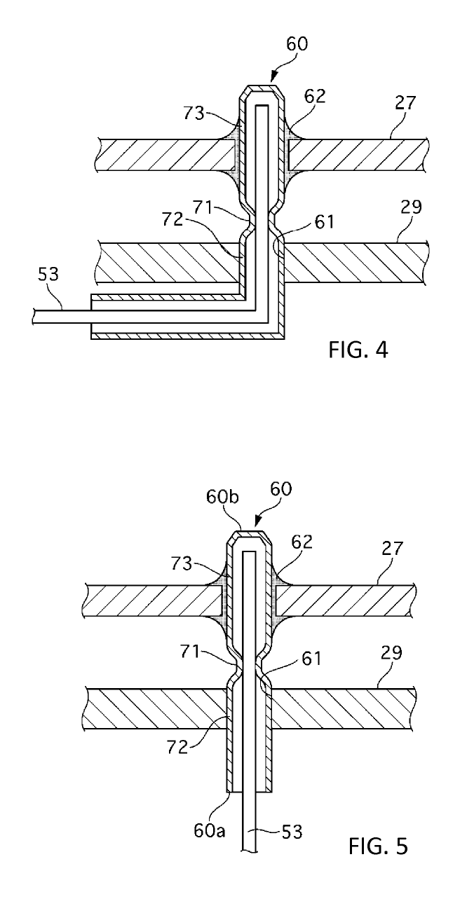

On the other hand, the first embodiment is configured such that only the end portion of the coil wire 53 is covered by the thin-walled narrow tube 60. Therefore, since the other portion of the coil wire not covered by the thin-walled narrow tube 60 can flexibly be routed, the rising position (the joint position between the thin-walled narrow tube 60 and the control circuit board 27) of the coil wire 53 can arbitrarily be changed. Additionally, the thin-walled narrow tube 60 can easily be bent by a worker after the coil wire 53 has been inserted into the thin-walled narrow tube 60 as shown in FIG. 4. Specifically, the rising position can arbitrarily be changed by the routing of a connecting wire. Thus, the first embodiment is advantageous in the flexibility to deal with the modification of the pattern of the control circuit board and the change of the motor in size and position compared with the conventional technology in which the connecting terminal is secured to the insulator of the stator.

Referring to FIG. 5, the thin-walled narrow tube 60 has such an axial size that the opening 60a side thereof largely projects from the obstruction portion 29 toward the motor housing portion 13. During the formation of the inverter housing 26, the thin-walled narrow tube 60 is insert-molded and secured to the obstruction portion 29. Thereafter, the coil wire 53 is inserted into the thin-walled narrow tube 60 and both are joined to each other. In this case, fusing or resistance welding can be done from not only the side of the control circuit board 27 but the side of the motor housing portion 13. Thus, workability during the assembly can be improved.

In the first embodiment, the press-fitting portion 72 and soldering portion 73 of the thin-walled narrow tube 60 are each formed in a circular shape. Since the press-fitting portion 72 is made circular, stress concentration on the press-fitting portion 72 can be alleviated when the thin-walled narrow tube 60 is press-fitted into the through-hole 61 of the obstruction portion 29. In addition, the outer circumference of the soldering portion 73 is shaped in a circular shape; therefore, stress concentration on the soldering portion 73 can be alleviated during the soldering.

In the first embodiment, the double-face-width portions 71a, 71a are formed at the coil wire joint portion 71 of the thin-walled narrow tube 60 by the forming process. Therefore, when the coil wire 53 inserted into the thin-walled narrow tube 60 is joined thereto by fusing or resistance welding, the distance from the coil wire 53 can be reduced. Therefore, the position of the coil wire 53 can be stabled and at the same time the amount of deformation of the thin-walled narrow tube 60 can be reduced during the joining. Further, a load and a current concentrate on the portion subjected to the forming process during the joining; therefore, the joining can be promoted.

A description is next given of effects of the first embodiment.

The electric oil pump 1 of the first embodiment produces the effects listed below.

(1) In the mechanical and electrical-integrated drive unit in which the motor 9 and the control circuit board 27 adapted to control the energization of the motor 9 are installed integrally with each other, the coil wire 53 of the motor 9 is covered at the end thereof by the conductive thin-walled narrow tube 60 so as to be joined to the thin-walled narrow tube 60. The thin-walled narrow tube 60 is fixedly inserted into the through-hole 61 formed in the obstruction portion 29 isolating the motor 9 from the control circuit board 29, in such a manner that at least the leading end portion of the thin-walled narrow tube 60 is projected into the inverter housing (case) 26 in which the control circuit board 27 is housed. In this way, the thin-walled narrow tube 60 is joined to the control circuit board 27.

With the configuration described above, the thin-walled narrow tube 60 functions as the insert terminal for obstructing the through-hole 61 so as to be able to obstruct the gap between the inner circumference of the through-hole 61 and the outer circumference of the coil wire 53. Therefor, it is possible to suppress the entering of operating fluid, a high-temperature environment or a contaminant into the inverter housing 26 via the gap.

The configuration described above can improve the flexibility of layout of the joint position between the thin-walled narrow tube 60 and the control circuit board 27 and the electronic components mounted on the control circuit board 27. Further, the configuration can simplify the joint structure between the coil wire 53 and the control circuit board 27. Additionally, positioning of the thin-walled narrow tube 60 with respect to the control circuit board 27 is facilitated and is made accurate. Thus, workability during the assembly can be improved.

(2) The thin-walled narrow tube 60 has the double-face-width portions 71a, 71a joined to the coil wire 53.

With this, when the coil wire 53 inserted into the thin-walled narrow tube 60 is joined thereto by fusing or resistance welding, the distance from the coil wire 53 can be reduced. Therefore, the position of the coil wire 53 can be stabled and at the same time the amount of deformation of the thin-walled narrow tube 60 can be reduced during the joining. Further, a load and a current concentrate on the portion subjected to the forming process during the joining; therefore, the joining can be promoted.

(3) The gap between the outer circumference of the thin-walled narrow tube 60 and the inner circumference of the through-hole 61 can be obstructed with an adhesive.

With this, the through-hole 61 can be obstructed completely, so that it is possible to prevent operating fluid, a high-temperature atmosphere or a contaminant from entering the inverter housing 26 via the gap.

### Other Embodiments

The mechanical and electrical-integrated drive unit of the present invention is described above with reference to the first embodiment. However, the specific configuration of the present invention is not limited to the configuration of the first embodiment.

For example, the first embodiment describes the mechanical and electrical-integrated drive unit applied to the electric oil pump by way of example. However, even if the mechanical and electrical-integrated drive unit is applied to other drive units, the same functions and effects as those of the first embodiment can be produced.

Also the shape of the thin-walled narrow tube is not limited to the first embodiment.

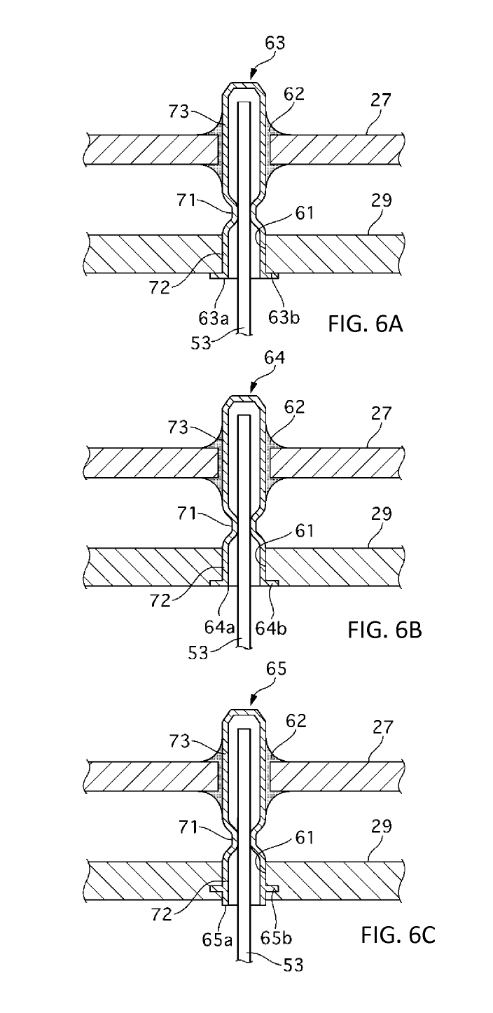

FIGS. 6A, 6B and 6C are longitudinal cross-sectional views of thin-walled narrow tubes according other embodiments.

FIG. 6A illustrates a thin-walled narrow tube 63 which is fixedly press-fitted into a through-hole 61 of an obstruction portion 29. The thin-walled narrow tube 63 has a flange portion 63b at an end edge on an opening 63a side. When the thin-walled narrow tube 63 is press-fitted into the through-hole 61 of the obstruction portion 29, the flange portion 63b behaves as a positioning member. Therefore, positioning accuracy and workability can be improved during assembly.

FIGS. 6B and 6C illustrate thin-walled narrow tubes 64 and 65, respectively, insert-molded during the formation of an inverter housing 26 by way of example. The thin-walled narrow tube 64 of FIG. 6B has a flange portion 64b at an end edge on an opening 64a side similarly to the thin-walled narrow tube 63 in FIG. 6A. The thin-walled narrow tube 65 of FIG. 6C has a flange portion 65b at an end portion on an opening 65a side. The flange portions 64b, 65b are each embedded in the obstruction portion 29. In this way, the gap, i.e., the passage through which operating fluid, a high-temperature atmosphere or a contaminant passes serves as a labyrinth structure. Therefore, it is possible to more reliably prevent the entering of the operating fluid, a high-temperature atmosphere or a contaminant from entering an inverter housing 26.

Incidentally, in FIGS. 6A, 6B and 6C, an adhesive is applied between each of the thin-walled narrow tubes 63, 64, 65 and the through-hole 61, whereby the through-hole 61 can be sealed completely.

A coil wire joint portion of the thin-walled narrow tube (a tubular member) may not be reduced in diameter.

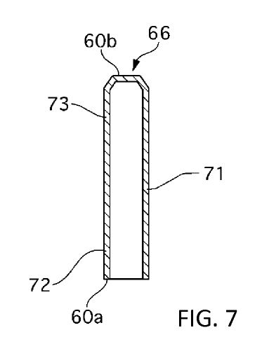

FIG. 7 is a longitudinal cross-sectional view of a thin-walled narrow tube according to another embodiment. A coil wire joint portion 71 of a thin-walled narrow tube 66 is not formed with a reduced-diameter portion shown in the embodiment. That is to say, the coil wire joint portion 71 has the same outside and inside diameters as those of each of the press-fitting portion 72 and the soldering portion 73.

What is claimed is:

1. A mechanical and electrical-integrated drive unit comprising:
a motor;
a control circuit board adapted to control energization of the motor, the motor and the control circuit board being installed integrally with each other;
a conductive tubular member for joining a coil wire of the motor to the control circuit board;
a divider wall isolating the motor from the control circuit board; and
a case to house the control circuit board therein;
wherein the coil wire of the motor is covered at an end thereof by the conductive tubular member and the coil wire and the tubular member are joined to each other, and
wherein the tubular member is fixedly inserted into a through-hole formed in the divider wall in such a manner that at least an leading end portion of the tubular member is projected into the inside of the case, and the tubular member is joined to the control circuit board.

2. The mechanical and electrical-integrated drive unit according to claim 1,
wherein the tubular member has a reduced-diameter portion joined to the coil wire.

3. The mechanical and electrical-integrated drive unit according to claim 1,
wherein a gap between an outer circumference of the tubular member and an inner circumference of the through-hole is obstructed by an adhesive.

4. The mechanical and electrical-integrated drive unit according to claim 2,
wherein a gap between an outer circumference of the tubular member and an inner circumference of the through-hole is obstructed by an adhesive.

5. The mechanical and electrical-integrated drive unit according to claim 1,
wherein the tubular member has a flange portion in contact with a circumferential edge of the through-hole.

6. The mechanical and electrical-integrated drive unit according to claim 2,
wherein the tubular member has a flange portion in contact with a circumferential edge of the through-hole.

7. The mechanical and electrical-integrated drive unit according to claim 3,
wherein the tubular member has a flange portion in contact with a circumferential edge of the through-hole.
